(19) United States
(12) Patent Application Publication
(10) Pub. No.: US 2025/0232910 A1
(43) Pub. Date: Jul. 17, 2025

(54) BOBBIN-LESS TRANSFORMER WITH WINDINGS EACH OF THREE-LAYER INSULATING WIRE HAVING SELF-FUSING LAYER

(71) Applicant: Panasonic Intellectual Property Management Co., Ltd., Osaka (JP)

(72) Inventor: Takehiko YAMAKAWA, Osaka (JP)

(21) Appl. No.: 18/844,578

(22) PCT Filed: Jan. 18, 2023
(86) PCT No.: PCT/JP2023/001261

§ 371 Date: Sep. 6, 2024

(30) Foreign Application Priority Data
Mar. 9, 2022 (JP) 2022-036426

(51) Int. Cl. H01F 27/30; H01F 27/24; H01F 41/04

(52) U.S. Cl. CPC H01F 27/306; H01F 27/24; H01F 41/04

(57) ABSTRACT

The present disclosure provides a transformer in which, as a bobbin-less transformer not using a bobbin, winding variation of windings and variation in leakage inductance are reduced and the reliability is improved. A transformer comprises a plurality of cores including a first core and a second core, and having windings mounted to the respective cores. The transformer comprises a first winding provided to the first core and a second winding provided to the second core. The first core and the second core are disposed to face each other, and the first winding and the second winding are three-layered insulating wires each in which a self-fusing layer is located on the outer side of a conducting wire coated with an insulating layer. Further, the first winding and the first core are configured to be connected to each other via the self-fusing layer or an adhesive layer.

### TECHNICAL FIELD

The present disclosure relates to a transformer used in a power conversion circuit such as a DC-DC converter, a method of manufacturing the same, a charging apparatus including the transformer, and a power supply apparatus including the transformer.

### BACKGROUND ART

Conventionally, an on-vehicle charger for charging a rechargeable battery by electronic power from a commercial power source is mounted on an electric vehicle or a plug-in hybrid vehicle. For example, Patent Document 1 and Patent Document 2 disclose them. Patent Document 1 discloses a transformer in which a winding is wound around a bobbin to ensure insulation, and Patent Document 2 discloses a transformer using a self-fusion three-layer insulating wire without using a bobbin.

### PRIOR ART DOCUMENT

### Patent Documents

Patent Document 1: Japanese patent No. JP5974833B2
Patent Document 2: Japanese utility model laid-open publication No. JPH06-70223U

### SUMMARY OF THE INVENTION

### Problems to be Solved by the Invention

However, when a bobbin is used to secure insulation between the core and the winding and between the windings as in Patent Document 1, there are such problems that the transformer becomes large in size, and a potting material made of silicone rubber or the like for heat dissipation is less likely to spread due to the closedness of the winding, resulting in a decrease in heat dissipation. In addition, in a case where the self-fusion three-layer insulating wire is applied without using a bobbin as in Patent Document 2, although size reduction is realized, since there is no bobbin, a winding position is not fixed, a positional relationship between windings varies, a value of a leakage inductance indicating a coupling state between a primary winding and a secondary winding varies, a circuit operation is hindered, and there are problems such as efficiency reduction and eventually charge stop.

The present disclosure has been made in view of the above points, and an object of the present disclosure is to provide a transformer that achieves size reduction without using a bobbin, reduces a variation in a leakage inductance value, stabilizes an operation of a DC-DC converter due to resonance using the leakage inductance value, further enhances heat dissipation of a winding, and improves reliability.

Another object of the present disclosure is to provide a method for manufacturing the transformer, a charging apparatus including the transformer, and a power supply apparatus including the transformer.

### Solutions to the Problems

According to one aspect of the present disclosure, there is provided a transformer including a plurality of cores including a first core and a second core. Each of the plurality of cores includes a winding mounted to corresponding one of the plurality of cores. The transformer includes a first winding mounted to the first core; and a second winding mounted to the second core. The first core and the second core are arranged to face each other, and each of the first winding and the second winding is a three-layer insulating wire having a self-fusing layer outside a conductive wire covered with an insulating layer.

### Effects of the Invention

Therefore, according to the transformer and the like of the present disclosure, the bobbin-less transformer is configured by the primary winding and the secondary winding made of the self-fusion wire to achieve downsizing. Even in the case of the bobbin less, for example, the primary winding is mounted along the middle leg of the upper core, and the secondary winding is mounted along the middle leg of the lower core. As a result, the variation in the positional relationship between the primary winding and the secondary winding is reduced, and the electrical stability of the leakage inductance and the manufacturability of the transformer can be improved. Therefore, the reliability of the transformer can be enhanced. In addition, the bobbin requiring a plurality of dies can be removed, and this can also contribute to cost reduction.

### BRIEF DESCRIPTION OF THE DRAWINGS

FIG. 1 is a block diagram illustrating a configuration example of an on-vehicle charger 101 according to an embodiment of the present disclosure.

FIG. 2 is a circuit diagram illustrating a configuration example of an LLC resonant type DC-DC converter 105 in FIG. 1.

FIG. 3 is a perspective view illustrating an appearance of a transformer 206 in FIG. 2.

FIG. 4A is a longitudinal sectional view taken along line A-A′ in FIG. 3.

FIG. 4B is a transverse cross-sectional view taken along line B-B′ in FIG. 3.

FIG. 5 is a cross-sectional view of a self-fusion wire of a primary winding 306 and a secondary winding 303 of a transformer 206 in FIG. 2.

FIG. 6 is a longitudinal sectional view of a transformer 206A according to a modified embodiment 1 when the primary winding 306 and the secondary winding 303 of the transformer 206 in FIG. 2 are mounted and fixed with an adhesive layer.

FIG. 7 is a longitudinal sectional view of a transformer 206B according to a modified embodiment 2 when the lower core 301 of the transformer 206 in FIG. 2 has a U shape and an upper core 304 has a T shape.

FIG. 8 is a longitudinal sectional view of a transformer 206C according to a modified embodiment 3 when the lower core 301 of the transformer 206 in FIG. 2 has an E shape, the secondary winding 303 is wound along the outer leg, the upper core 304 has an E shape, and the primary winding 306 is wound along the middle leg.

FIG. 9 is a longitudinal sectional view of a transformer 206D according to a modified embodiment 4 configured by vertically interchanging the transformer 206 in FIG. 7 according to the modified embodiment 2.

FIG. 10 is a longitudinal sectional view of a transformer 206E according to a modified embodiment 5 when the upper core 304 of the transformer 206 in FIG. 2 according to the embodiment is formed of two U-shaped cores.

FIG. 11A is a longitudinal sectional view illustrating a first process in a manufacturing process of the transformer 206 in FIG. 4A.

FIG. 11B is a longitudinal sectional view illustrating a second process in the manufacturing process of the transformer 206 in FIG. 4A.

FIG. 11C is a longitudinal sectional view illustrating a third process in the manufacturing process of the transformer 206 in FIG. 4A.

FIG. 11D is a longitudinal sectional view illustrating a fourth process in the manufacturing process of the transformer 206 in FIG. 4A.

FIG. 11E is a longitudinal sectional view illustrating a fifth process in the manufacturing process of the transformer 206 in FIG. 4A.

FIG. 11F is a longitudinal sectional view illustrating a sixth process in the manufacturing process of the transformer 206 in FIG. 4A.

FIG. 11G is a longitudinal sectional view illustrating a seventh process in the manufacturing process of the transformer 206 in FIG. 4A.

FIG. 11H is a longitudinal sectional view illustrating an eighth process in the manufacturing process of the transformer 206 in FIG. 4A.

FIG. 12A is a longitudinal sectional view illustrating a first process in a manufacturing process of the transformer 206A in FIG. 6.

FIG. 12B is a longitudinal sectional view illustrating a second process in the manufacturing process of the transformer 206A in FIG. 6.

FIG. 12C is a longitudinal sectional view illustrating a third process in the manufacturing process of the transformer 206A in FIG. 6.

FIG. 12D is a longitudinal sectional view illustrating a fourth process in the manufacturing process of the transformer 206A in FIG. 6.

FIG. 12E is a longitudinal sectional view illustrating a fifth process in the manufacturing process of the transformer 206A in FIG. 6.

FIG. 12F is a longitudinal sectional view illustrating a sixth process in the manufacturing process of the transformer 206A in FIG. 6.

FIG. 12G is a longitudinal sectional view illustrating a seventh process in the manufacturing process of the transformer 206A in FIG. 6.

FIG. 12H is a longitudinal sectional view illustrating an eighth process in the manufacturing process of the transformer 206A in FIG. 6.

FIG. 12I is a longitudinal sectional view illustrating a ninth process in the manufacturing process of the transformer 206A in FIG. 6.

FIG. 12J is a longitudinal sectional view illustrating a tenth process in the manufacturing process of the transformer 206A in FIG. 6.

FIG. 12K is a longitudinal sectional view illustrating an eleventh process in the manufacturing process of the transformer 206A in FIG. 6.

FIG. 12L is a longitudinal sectional view illustrating a twelfth process in the manufacturing process of the transformer 206A in FIG. 6.

FIG. 13A is a longitudinal sectional view illustrating a first process in a manufacturing process of the transformer 206B in FIG. 7.

FIG. 13B is a longitudinal sectional view illustrating a second process in the manufacturing process of the transformer 206B in FIG. 7.

FIG. 13C is a longitudinal sectional view illustrating a third process in the manufacturing process of the transformer 206B in FIG. 7.

FIG. 13D is a longitudinal sectional view illustrating a fourth process in the manufacturing process of the transformer 206B in FIG. 7.

FIG. 13E is a longitudinal sectional view illustrating a fifth process in the manufacturing process of the transformer 206B in FIG. 7.

FIG. 13F is a longitudinal sectional view illustrating a sixth process in the manufacturing process of the transformer 206B in FIG. 7.

FIG. 13G is a longitudinal sectional view illustrating a seventh process in the manufacturing process of the transformer 206B in FIG. 7.

FIG. 13H is a longitudinal sectional view illustrating an eighth process in the manufacturing process of the transformer 206B in FIG. 7.

### DETAILED DESCRIPTION

Hereinafter, embodiments and modified embodiments according to the present disclosure will be described with reference to the drawings. It is noted that the same or similar components are denoted by the same reference numerals.

### Findings of Inventors

Hereinafter, the embodiment of the present disclosure will be described with reference to the drawings.

### Embodiment

Hereinafter, a transformer according to the embodiment of the present disclosure will be described in detail with reference to the drawings. However, the configuration described below is merely an example of the present disclosure, and the present disclosure is not limited to the following embodiment, and various modifications can be made according to the design and the like without departing from the technical idea according to the present disclosure even in a case other than this embodiment.

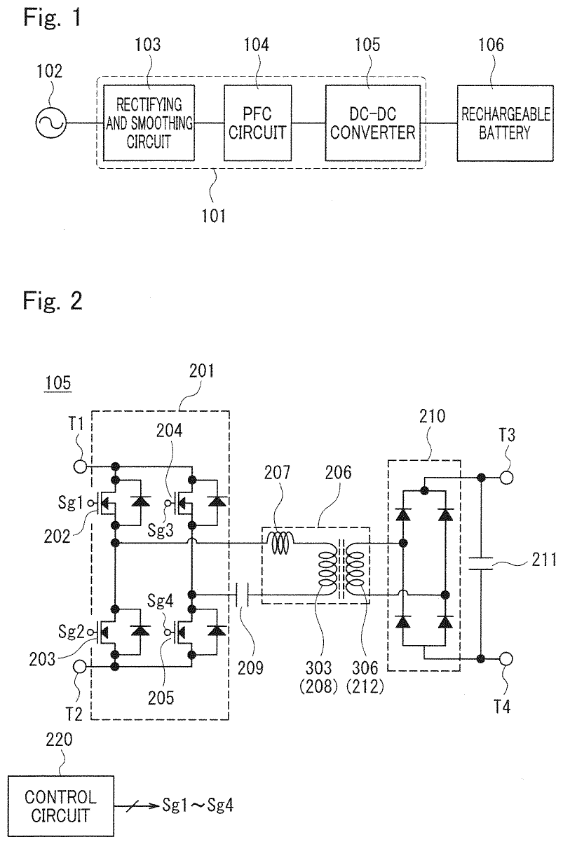

FIG. 1 is a block diagram illustrating a configuration example of an on-vehicle charger 101 according to an embodiment of the present disclosure. The on-vehicle charger 101 in FIG. 1 is characterized in that AC power from a commercial AC power supply 102 is converted into DC power, and output to a rechargeable battery 106, and a transformer 206 incorporated in a DC-DC converter 105 insulates before and after the conversion.

Referring to FIG. 1, the on-vehicle charger 101 includes a rectifying and smoothing circuit 103, a power factor correction circuit (PFC circuit) 104, and a DC-DC converter 105. For example, in an electric vehicle or a plug-in hybrid vehicle, the rectifying and smoothing circuit 103 rectifies and smooths the AC power from the commercial AC power supply 102 of 100 V or 200 V by the rectifying and smoothing circuit 103. Next, the PFC circuit 104 suppresses power factor improvement and harmonics with respect to the rectified and smoothed voltage to be input, and the DC-DC converter 105 converts the voltage to be input into a DC output voltage corresponding to the battery voltage of the rechargeable battery 106 at the subsequent stage, and outputs the voltage to the rechargeable battery 106.

FIG. 2 is a circuit diagram illustrating a configuration example of the DC-DC converter 105 in FIG. 1. In the present embodiment, as an example, an LLC resonant type DC-DC converter 105 widely used for a high-efficiency power supply, such as an industrial switching power supply, an in-vehicle charging apparatus, and a power converter, is used as the DC-DC converter.

Referring to FIG. 2, the LLC resonant type DC-DC converter 105 includes input terminals T1 and T2, and output terminals T3 and T4. The LLC resonant type DC-DC converter 105 includes an inverter circuit 201, a resonance capacitor 209, a transformer 206, a rectifier circuit 210, a smoothing capacitor 211, and a control circuit 220 between an input terminal and an output terminal. The control circuit 220 generates gate signals Sg1 to Sg4 for controlling the operation of the inverter circuit 201. In this case, the inverter circuit 201 is configured by connecting, for example, N-channel MOS transistors 202 to 205, which are switching elements, in a bridge form. The inverter circuit 201 converts a DC voltage into an AC voltage by turning on or off the MOS transistors 202 to 205 according to the gate signals Sg1 to Sg4. The transformer 206 includes a leakage inductance 207, an excitation inductance 208 as a primary winding, and an inductance 212 as a secondary winding.

Synchronized signals are input as the gate signal Sg1 and the gate signal Sg4. In a manner similar to above, synchronized signals are input as the gate signal Sg2 and the gate signal Sg3. As the gate signals Sg2 and Sg3, signals inverted from the gate signals Sg1 and Sg4 are input.

Therefore, the MOS transistor 202 and the MOS transistor 205 are turned on or off in synchronization with each other according to the gate signal Sg1 and the gate signal Sg4. In a manner similar to above, the MOS transistors 203 and 204 are turned on or off in synchronization with each other according to the gate signal Sg2 and the gate signal Sg3. Then, the MOS transistors 202 and 205 and the MOS transistors 203 and 204 are inverted and controlled. That is, at the same time as the MOS transistors 202 and 205 are turned on, the MOS transistors 203 and 204 are turned off. Further, at the same time as the MOS transistors 202 and 205 are turned off, the MOS transistors 203 and 204 are turned on.

In the DC-DC converter 105, the inverter circuit 201 converts an input voltage into an AC voltage by switching the input voltage, and outputs the AC voltage to the rectifier circuit 210 via the resonance capacitor 209 and the transformer 206. In this case, the output voltage is changed using a frequency modulation method of changing the switching frequencies of the four MOS transistors 202 to 205 by using the resonance of two inductances and one capacitor including the leakage inductance 207 of the transformer 206, the excitation inductance 208 of the primary winding 303, and the resonance capacitor 209. Next, the output voltage from the transformer 206 is output from the inductance 212 of the secondary winding 306 to the rectifier circuit 210, and the rectifier circuit 210 rectifies the input AC voltage. The rectified voltage is smoothed by the smoothing capacitor 211, and then, the rectified and smoothed DC voltage is output.

With the DC-DC converter 105 configured as described above, the switching loss can be reduced by the zero voltage switching, and the surge current and the voltage can be reduced by the switching current close to the sine wave, and the noise can be reduced.

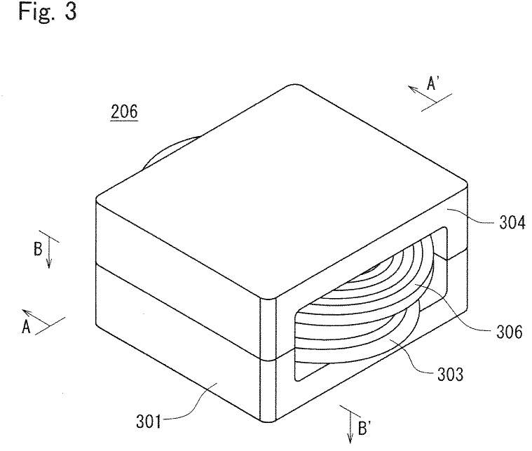

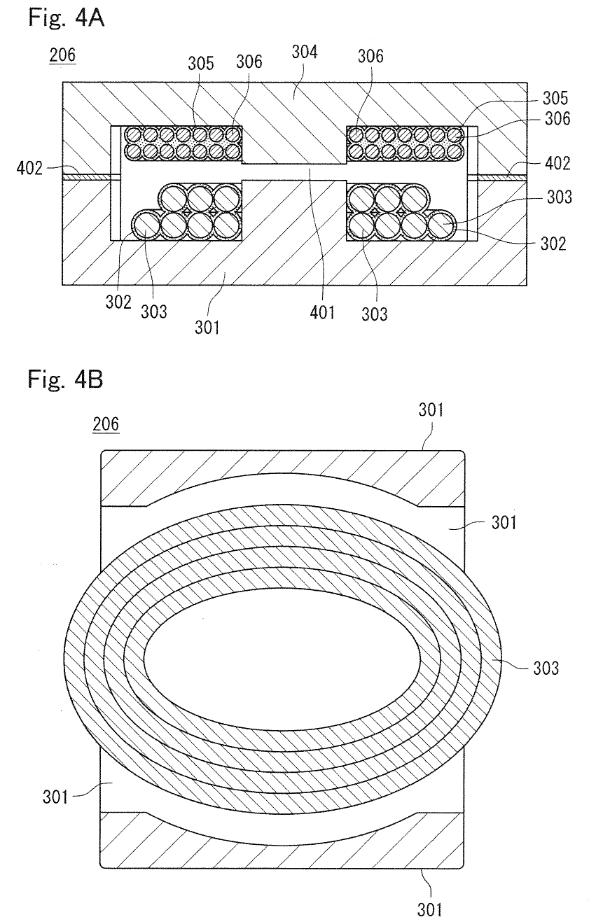

FIG. 3 is a perspective view illustrating an appearance of the transformer 206 in FIG. 2, FIG. 4A is a longitudinal sectional view taken along line A-A′ in FIG. 3, and FIG. 4B is a transverse sectional view taken along line B-B′ in FIG. 3. In the following description, up, down, left, and right in FIGS. 3, 4A, and 4B will be described as up, down, left, and right directions, respectively, however, it is not intended to limit the use form of the transformer 206. In the longitudinal sectional views and the like after FIG. 4A, the primary winding 303 and the secondary winding 306 actually rise or fall in a spiral shape, but illustration thereof is omitted for simplification of illustration.

Referring to FIGS. 3, 4A, and 4B, the transformer 206 includes an E-shaped lower core 301 having an E-shape in a longitudinal section and an E-shaped upper core 304 having an E-shape in a longitudinal section.

The lower core 301 is made of a magnetic material such as ferrite or an electromagnetic steel plate, has a middle leg having a circular shape, an elliptical shape, or the like, and includes outer legs on both sides of the middle leg. In this case, as illustrated in FIG. 4A, a secondary winding 303 including a three-layer insulating wire (for example, it is also referred to as a self-fusion wire) having a self-fusing layer 302 outside a covered conductor is wound and mounted to the lower core 301 along the middle leg. In this case, the secondary winding 303 is fixed to the lower core 301 by melting and cooling the self-fusing layer 302 by heat generation by a solvent or energization or heating by an oven.

In a manner similar to that of the lower core 301, the upper core 304 is made of a magnetic material such as ferrite or an electromagnetic steel plate, has a middle leg having a circular shape, an elliptical shape, or the like, and includes outer legs on both sides of the middle leg. As illustrated in FIG. 4A, the primary winding 306 including a three-layer insulating wire having a self-fusing layer 305 is wound and mounted to the upper core 304 along the middle leg. In this case, the primary winding 306 is fixed to the upper core 304 by melting and cooling the self-fusing layer 305 by heat generation by a solvent or energization or heating by an oven.

The upper core 304 and the lower core 301 have middle legs facing each other at a certain distance and with a gap 401 interposed therebetween, and outer legs of the cores 304 and 301 are bonded to each other with an adhesive layer 402 interposed therebetween to form a transformer 206. Usually, the primary winding and the secondary winding made of a single wire, a litz wire, or the like in which the insulating layer is formed on the outer side are designed to be separated from each other by a space distance and a creepage distance defined in each specification in order to ensure insulation between the windings and between the core and the winding. In many cases, the primary winding and the secondary winding are separated from each other by a bobbin made of an insulating material.

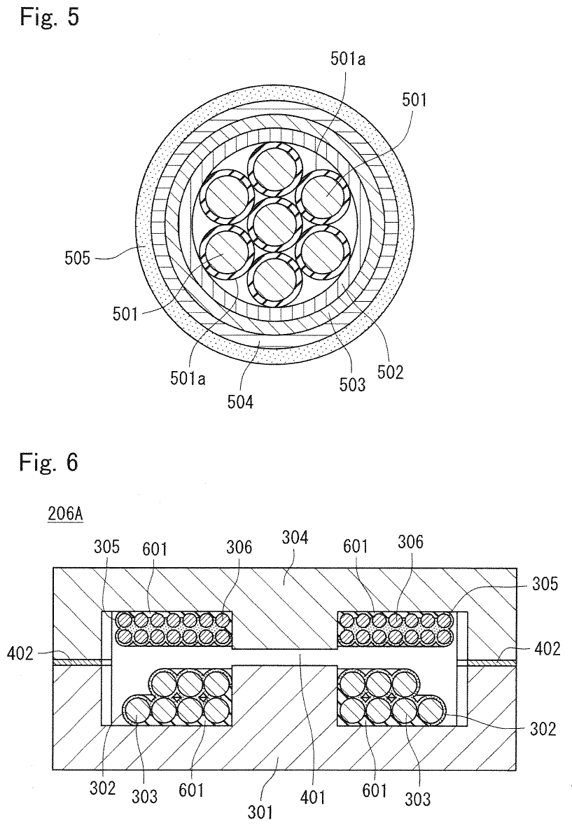

FIG. 5 is a cross-sectional view of a self-fusion wire of the primary winding 306 and the secondary winding 303 of the transformer 206 in FIG. 2.

Referring to FIG. 5, the primary winding 306 and the secondary winding 303 are made of a three-layer insulating wire including a self-fusing layer 505. In the self-fusion wire, in a winding including a plurality of conductors 501 coated with an insulating layer 501a, a first insulating layer 502 is formed and disposed, a second insulating layer 503 is formed and disposed from above the first insulating layer 502, and a third insulating layer 504 is formed from above the second insulating layer 503 and outside the plurality of conductors 501, and a self-fusing layer 505 is formed as an outermost layer.

With this structure, it is possible to realize a transformer that is completely insulated and separated, and secures insulation between the windings and between the winding and the core without using a bobbin. As a result, size reduction can be realized, and there is an example in which, in a certain transformer, the transformer size can be reduced to about 70% by adopting a bobbin-less structure in which a self-fusion wire is applied to a winding without changing the number of turns, an inductance value, and the like, and redesigning the core size with the same heat generation density.

In the transformer using the bobbin, the leakage inductance 207 based on the interval between the primary winding and the secondary winding is stable, but in the general bobbin-less transformer, the positional relationship between the primary winding and the secondary winding varies depending on the winding method, and the leakage inductance 207 also varies. Regarding the variation in the leakage inductance 207, in the LLC resonant type DC-DC converter, the resonance frequency varies, a desired output voltage ratio cannot be realized, and the charging operation may not be performed.

However, in a manner similar to that of the present embodiment, by winding and fixing along the middle leg and the core flat surface of each of the cores 304 and 301, the primary winding 306 is positioned in the upper core 304, and the secondary winding 303 is similarly positioned in the lower core 301. Further, the upper core 304 and the lower core 301 can be fired or formed with high accuracy, and the outer legs of the upper core 304 and the outer legs of the lower core 301 formed with high accuracy are bonded via the adhesive layer 402, which makes the leakage inductance 207 associated with the degree of coupling between the primary winding 306 and the secondary winding 303 be stabilized.

The inductance value L1 of the excitation inductance 208 is generally expressed by the following equation (1) using the effective permeability μ, the effective cross-sectional area S, the number of turns N, and the effective magnetic path length Le.

$$L 1 = μ \cdot S \cdot {N}^{2} / Le \qquad ( 1 )$$

In this case, as in the present embodiment, by adopting the bobbin-less transformer, the core size can be downsized, the effective magnetic path length Le is shortened, and the excitation inductance 208 is increased. However, it is easy to adjust the desired excitation inductance 208 by adjusting the gap 401, adjusting the effective permeability μ, or redesigning the effective cross-sectional area S.

The leakage inductance 207 is a parameter that is also affected by the excitation inductance 208 and is set accordingly. In addition, these inductance values are set including the heights of the outer legs of the upper core 304 and the lower core 301 that determine the distance between the primary winding 306 and the secondary winding 303.

In a normal bobbin-equipped transformer, winding a winding around a bobbin makes it difficult for a potting resin made of silicone rubber for enhancing heat dissipation to spread inside the winding, and heat dissipation is deteriorated. However, by providing a self-fusion wire as in the present embodiment, the size of the winding itself is increased by the amount of the insulating layer. However, the bobbin less is obtained, and the size of the transformer is reduced. In addition, the winding is exposed when the potting is not arranged. As a result, the winding can be arranged in the air passage to improve the heat dissipation, and the potting can be spread over the entire winding without hindering the penetration of the potting by the bobbin when the potting is arranged.

Furthermore, potting can be reliably disposed between the core and the winding, and heat generated from the winding can be effectively dissipated from the core, so that heat dissipation is enhanced. Further, when the heat dissipation is enhanced, not only abnormal heat generation of the core and the winding can be prevented, but also core cracking from the stress of the core due to core heat generation can be prevented, and an increase in core loss due to stress can be suppressed, and the highly efficient on-vehicle charger 101 can be realized.

### Modified Embodiment 1

FIG. 6 is a longitudinal sectional view of a transformer 206A according to a modified embodiment 1 when the primary winding 306 and the secondary winding 303 of the transformer 206 in FIG. 2 are mounted and fixed with an adhesive layer.

In FIG. 4A according to the embodiment, the primary winding 306 is wound around the middle leg of the upper core 304, and then, the self-fusing layer 305 is melted to fix the primary winding 306 to the upper core 304, and the secondary winding 303 is wound around the middle leg of the lower core 301. Then, the self-fusing layer 302 is melted to fix the secondary winding 303 to the lower core 301.

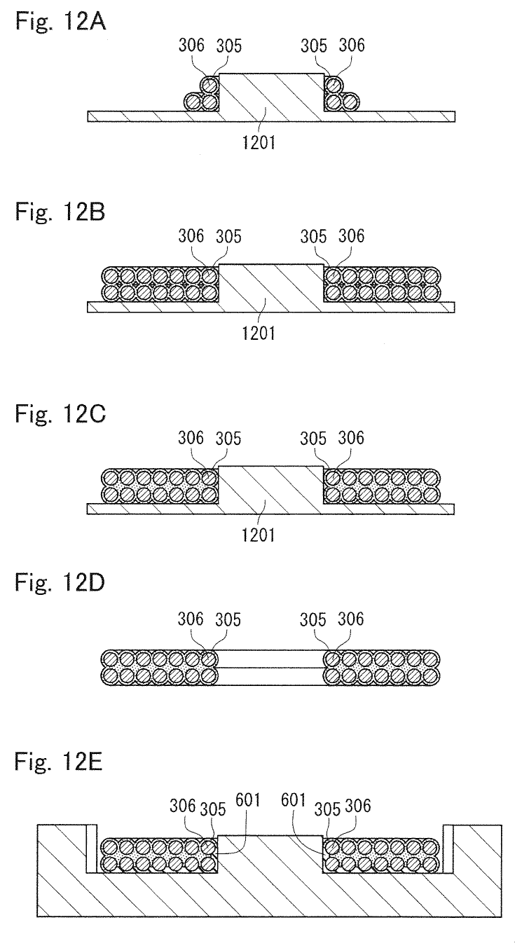

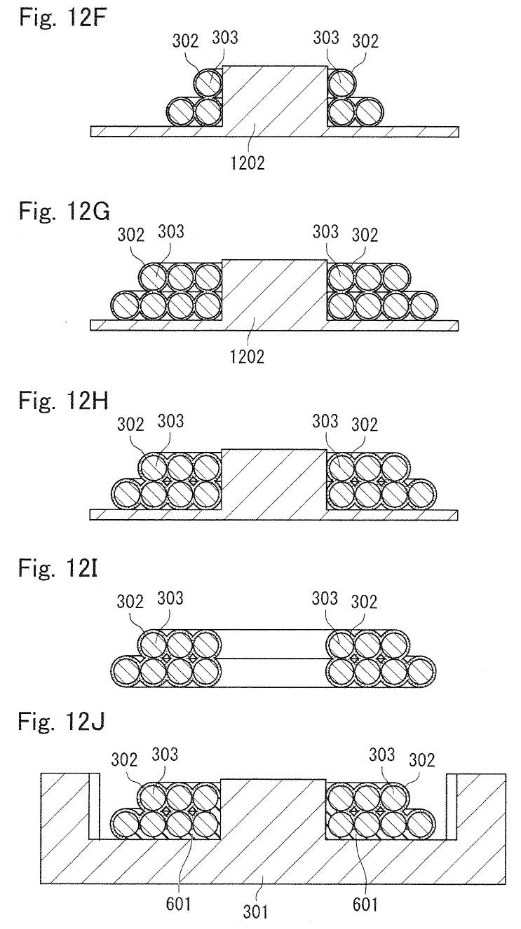

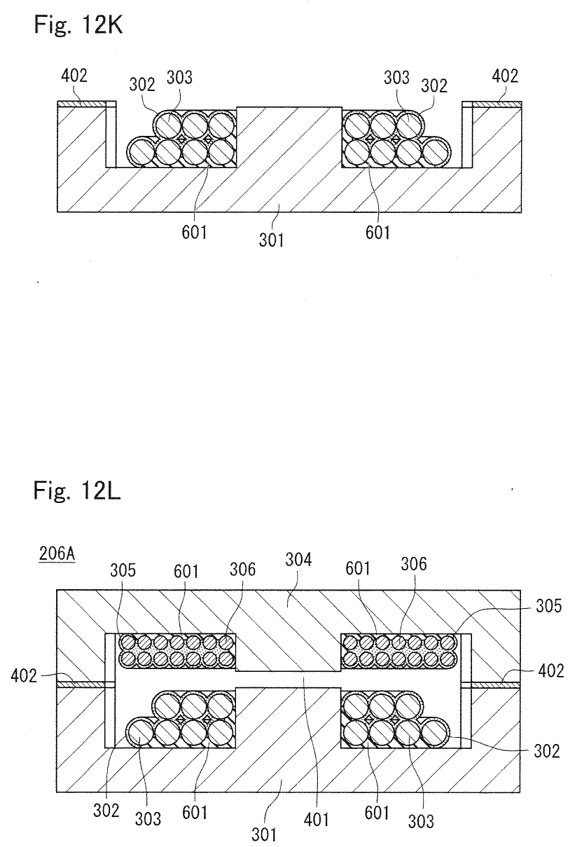

However, the present disclosure is not limited to this, and the primary winding 306 may be wound around a temporary bobbin 1201 (described in detail with reference to FIGS. 12A to 12C) or the like in advance, the self-fusing layer 305 may be melted, cooled, and fixed, then the temporary bobbin 1201 may be removed to integrally form only the primary winding 306. Then, the primary winding 306 may be fixed to the upper core 304 via an adhesive layer 601 such as epoxy resin as illustrated in FIG. 6. In a manner similar to above, the secondary winding 303 may be wound around a temporary bobbin 1202 (described later in detail with reference to FIGS. 12F to 12H) or the like in advance, the self-fusing layer 302 may be melted, cooled, and fixed. Then, the temporary bobbin may be removed to integrally form only the secondary winding, and then the secondary winding 303 may be fixed to the lower core 301 via an adhesive layer 601 such as epoxy resin as illustrated in FIG. 6.

### Modified Embodiment 2

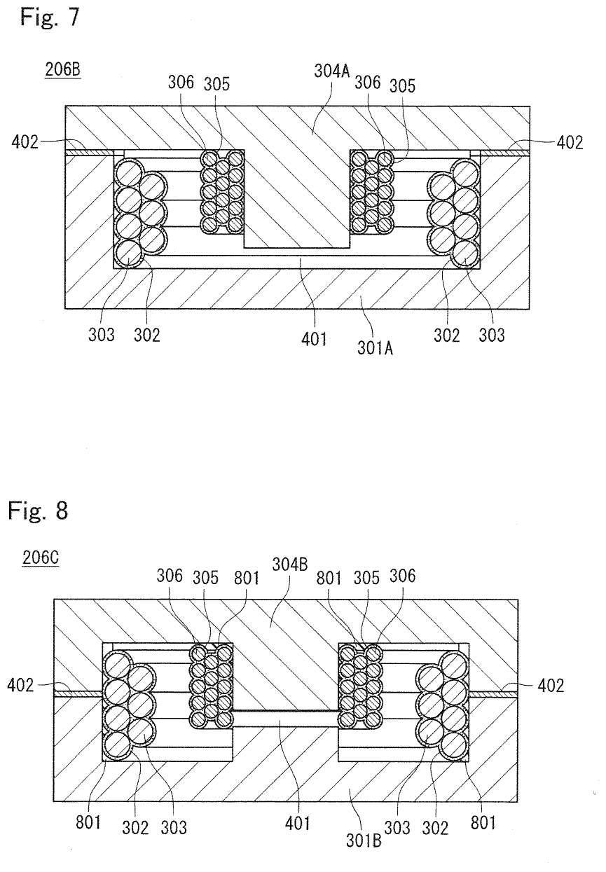

FIG. 7 is a longitudinal sectional view of a transformer 206B according to a modified embodiment 2 when the lower core 301 of the transformer 206 in FIG. 2 has a U shape and the upper core 304 has a T shape.

Referring to FIG. 4A according to the embodiment, the primary winding 306 and the secondary winding 303 are wound along the middle legs of the upper core 304 and the lower core 301, respectively. However, the present disclosure is not limited to this, and even when the lower core 301 has a U shape, the secondary winding 303 is wound along the outer leg, the upper core 304 has a T shape, and the primary winding 306 is wound along the middle leg as illustrated in FIG. 7, the positional relationship between the primary winding 306 and the secondary winding 303 is determined by the core shape, so that the variation in the leakage inductance 207 is reduced in a manner similar to that of FIG. 4A.

### Modified Embodiment 3

FIG. 8 is a longitudinal sectional view of a transformer 206C according to a modified embodiment 3 when the lower core 301 of the transformer 206 in FIG. 2 has an E shape, the secondary winding 303 is wound along the outer leg, the upper core 304 has an E shape, and the primary winding 306 is wound along the middle leg.

As illustrated in FIG. 8, even in the E-shaped core in a manner similar to that in FIG. 4, as illustrated in FIG. 6, only the primary winding 306 or only the secondary winding 303 may be fixed and formed in advance with a temporary bobbin (not illustrated) or the like, and then fixed to the upper core 304 and the lower core 301 via an adhesive layer 801 such as epoxy resin.

### Modified Embodiment 4

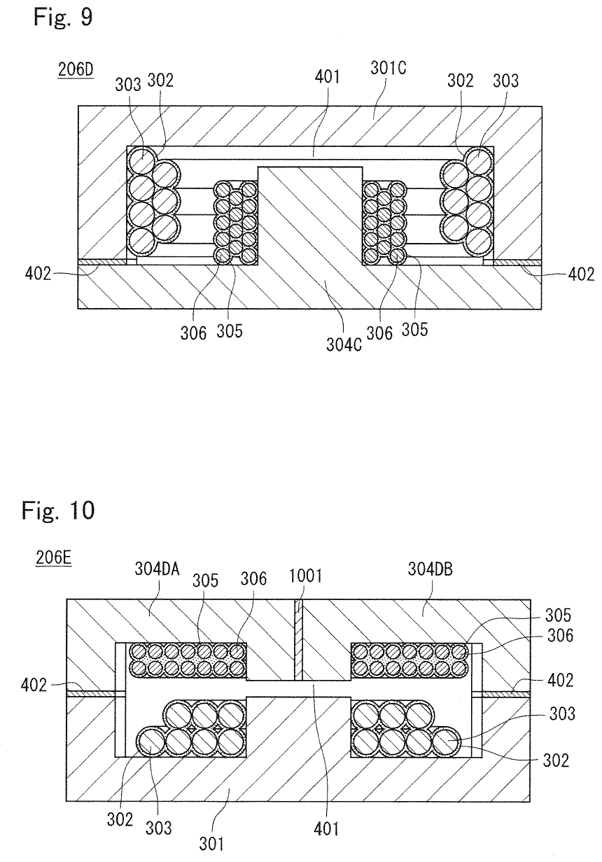

FIG. 9 is a longitudinal sectional view of a transformer 206D according to a modified embodiment 4 configured by interchanging the upper and lower sides of the transformer 206 in FIG. 7 according to the modified embodiment 2.

As illustrated in FIG. 9, the upper and lower sides may be interchanged in a manner similar to that of FIG. 7. Usually, a core loss in the middle leg is large, and a water-cooling apparatus (not illustrated) is often disposed on the lower side. In this case, heat generated in the middle leg can be dissipated to the water-cooling apparatus without passing through the gap 401, and the transformer 206D capable of stable operation is realized.

### Modified Embodiment 5

FIG. 10 is a longitudinal sectional view of a transformer 206E according to a modified embodiment 5 when the upper core 304 of the transformer 206 in FIG. 2 according to the embodiment is formed of two U-shaped cores.

As illustrated in FIG. 10, the upper core 304 may be divided into two U-shaped portions, and an insulating elastic body 1001 may be provided between the two U-shaped portions. In a case where a water-cooling apparatus (not illustrated) is disposed on the lower side, the cooling performance of the lower core 301 is good. However, the upper core 304 is likely to have a higher temperature than the lower core 301. A force is applied in a direction in which the upper core 304 expands and is stretched to the left and right. If a stress is applied, the core loss further increases, the temperature increases, the stress also increases, and in the worst case, core cracking occurs. However, dividing the upper core 304 into two U-shaped portions enable dispersing the stress to the left and right enables avoiding core cracking.

### Process Example 1 of Manufacturing Method

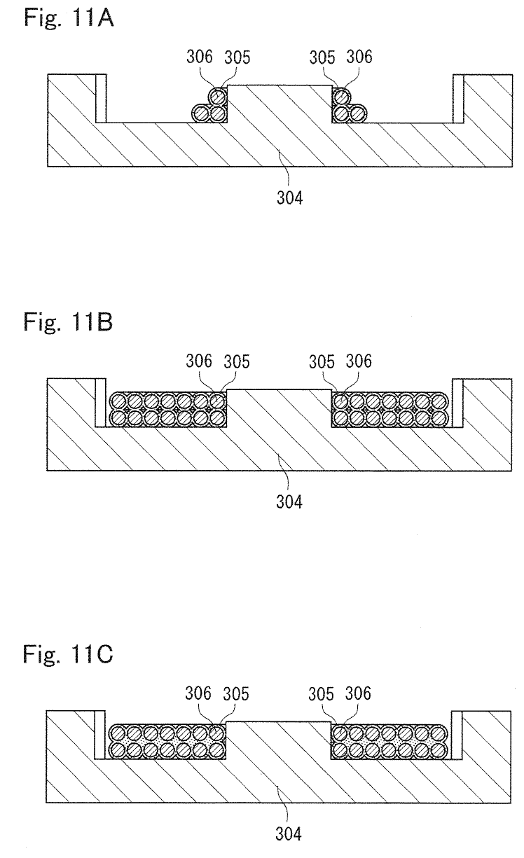

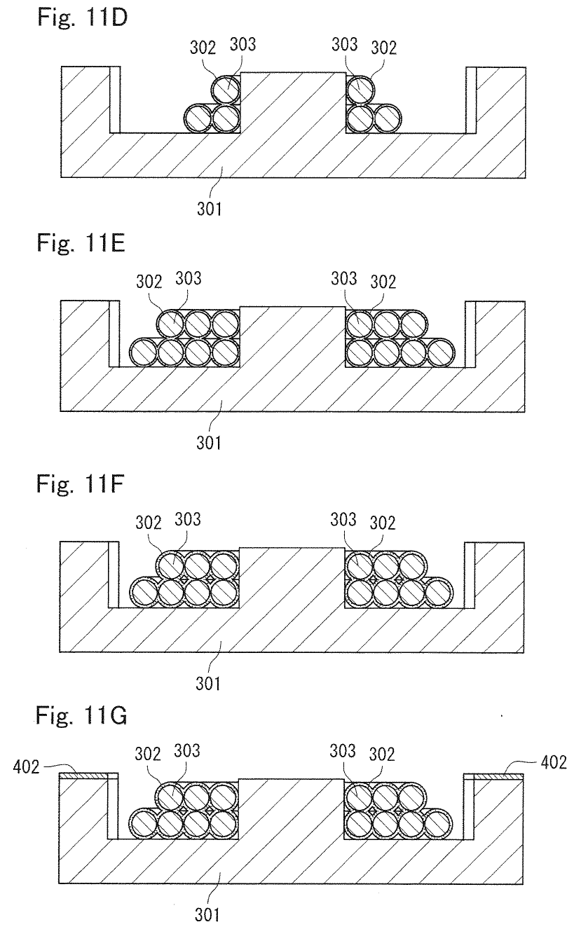

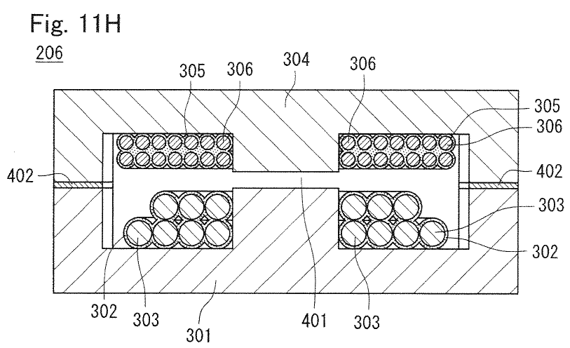

FIGS. 11A to 11H are longitudinal sectional views illustrating each process of the manufacturing process of the transformer 206 in FIGS. 3, 4A, and 4B according to the embodiment.

As illustrated in FIG. 11A, the primary winding 306 including the three-layer insulating wire having the self-fusing layer 305 along the middle leg of the E-shaped upper core 304 is wound from the inside in a two-stage configuration and alpha-winding. At this time, the lower side of the two-stage configuration is wound first, and the winding on the lower side is wound along the bottom surface of the core and is mounted, so that the variation in the winding position is reduced. Next, as illustrated in FIG. 11B, the primary winding 306 of a predetermined number of turns is wound. Further, as illustrated in FIG. 11C, the wound primary winding 306 is cooled after the self-fusing layer 305 is melted by heat generation by a solvent or energization or heating by an oven, and the primary windings 306 and the primary winding 306 and the upper core 304 are fixed and integrated. Reference numeral 305 in FIG. 11C denotes the self-fusing layer 305 after melting self-fusion.

In a manner similar to above, as illustrated in FIG. 11D, the secondary winding 303 including the three-layer insulating wire having the self-fusing layer 302 along the middle leg of the E-shaped lower core 301 is wound from the inside in a two-stage configuration by alpha-winding and mounted. At this time, the lower side of the two-stage configuration is wound first, and the winding on the lower side is wound along the bottom surface of the core, so that the variation in the winding position is reduced. Next, as illustrated in FIG. 11E, the secondary winding 303 having a predetermined number of turns is wound and mounted. Further, as illustrated in FIG. 11F, the wound secondary winding 303 is cooled after the self-fusing layer 302 is melted by heat generation by a solvent or energization or heating by an oven, so that the secondary windings 303 and the secondary winding 303 and the lower core 301 are fixed and integrated. The self-fusing layer 302 in FIG. 11F shows the self-fusing layer 302 after melting self-fusion.

Further, as illustrated in FIG. 11G, the adhesive layer 402 made of epoxy resin or the like is applied to the outer leg of the lower core 301. Finally, as illustrated in FIG. 11H, the upper core 304 to which the primary winding 306 is fixed is turned upside down, the outer legs of the lower core 301 and the outer legs of the upper core 304 are bonded to each other so as to face each other, and further the adhesive layer 402 is thermally cured and integrated to obtain the transformer 206 to be manufactured.

### Process Example 2 of Manufacturing Method

FIGS. 12A to 12L are longitudinal sectional views illustrating each process of the manufacturing process of the transformer 206A in FIG. 6 according to the modified embodiment 1.

As illustrated in FIG. 12A, the primary winding 306 including the three-layer insulating wire having the self-fusing layer 305 along the middle leg of the temporary bobbin 1201 is wound from the inside in a two-stage configuration by alpha winding. At this time, the lower side of the two-stage configuration of the primary winding 306 is wound first, and the primary winding 306 on the lower side is wound along the bottom surface of the temporary bobbin 1201, so that the variation in the winding position is reduced. Next, as illustrated in FIG. 12B, the primary winding 306 of a predetermined number of turns is wound. Further, as illustrated in FIG. 12C, the wound primary winding 306 is cooled after the self-fusing layer 305 is melted by heat generation by a solvent or energization or heating by an oven, and the primary windings 306 are fixed to each other.

Next, as illustrated in FIG. 12D, the temporary bobbin 1201 is removed to obtain a structure in which the primary windings 306 are integrated. The temporary bobbin 1201 is subjected to silicone processing or the like on the surface thereof to facilitate removal of the temporary bobbin 1201 by, for example, preventing fixation to the temporary bobbin 1201 by the self-fusing layer 305. Further, as shown in FIG. 12E, the primary winding 306 integrated by the self-fusing layer 305 is disposed and fixed to the upper core 304 via the adhesive layer 601 such as epoxy resin. In a manner similar to above, as illustrated in FIG. 12F, the secondary winding 303 including the three-layer insulating wire having the self-fusing layer 302 along the middle leg of the temporary bobbin 1202 is wound from the inside in a two-stage configuration by alpha-winding. At this time, the lower side of the two-stage configuration of the secondary winding 303 is wound first, and the secondary winding 303 on the lower side is wound along the bottom surface of the temporary bobbin 1202, so that the variation in the winding position is reduced. Next, as illustrated in FIG. 12G, the secondary winding 303 of a predetermined number of turns is wound.

Further, as illustrated in FIG. 12H, the wound secondary winding 303 is cooled after the self-fusing layer 302 is melted by heat generation by a solvent or energization or heating by an oven, and the secondary windings 303 are fixed to each other. Next, as illustrated in FIG. 12I, the temporary bobbin 1202 is removed to obtain a structure in which the secondary windings 303 are integrated. The temporary bobbin 1202 is subjected to silicone processing or the like on the surface thereof to facilitate removal of the temporary bobbin 1202 by, for example, preventing fixation to the temporary bobbin 1202 by the self-fusing layer 305. Further, as illustrated in FIG. 12J, the secondary winding 303 integrated by the self-fusing layer 302 is disposed and fixed to the lower core 301 via the adhesive layer 601 such as epoxy resin.

Next, as illustrated in FIG. 12K, the adhesive layer 402 made of epoxy resin or the like is applied to the outer leg of the lower core 301. Finally, as illustrated in FIG. 12L, the upper core 304 to which the primary winding 306 is fixed is turned upside down, and the outer legs of the lower core 301 and the outer legs of the upper core 304 are disposed so as to oppose each other to perform alignment. Further, the adhesive layer 402 is thermally cured, and these are integrated to obtain the transformer 206A to be manufactured.

### Process Example 3 of Manufacturing Method

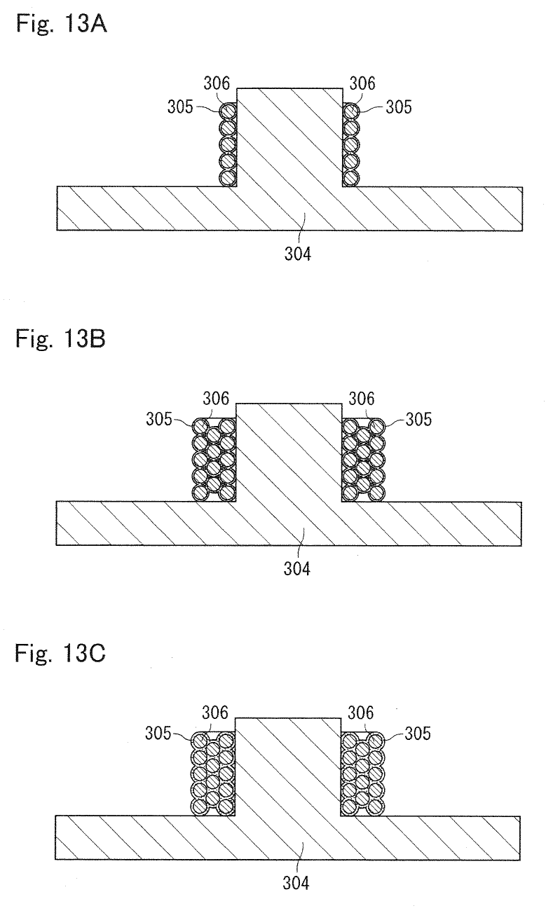

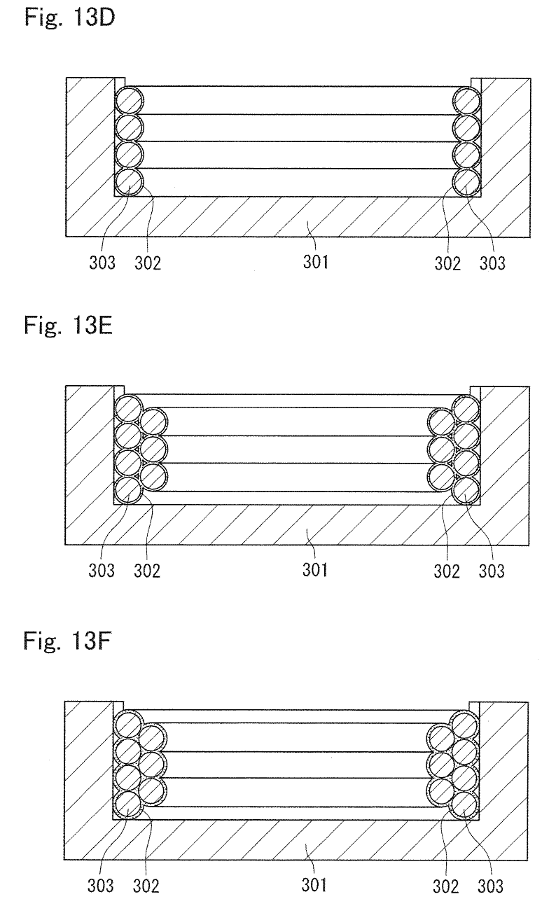

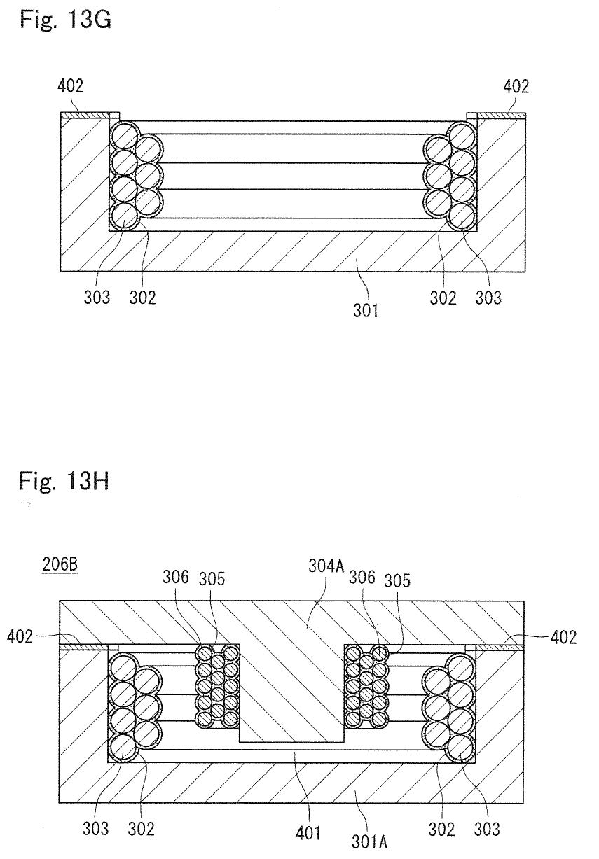

FIGS. 13A to 13H are longitudinal sectional views illustrating each process of the manufacturing process of the transformer 206B in FIG. 7 according to the modified embodiment 2.

As illustrated in FIG. 13A, the primary winding 306 including the three-layer insulating wire having the self-fusing layer 305 is wound from the inside along the middle leg of the T-shaped upper core 304. At this time, the primary winding 306 is wound along the surface on the long side of the upper core 304. Next, as illustrated in FIG. 13B, the second stage is wound along between the windings of the first stage of the primary winding 306 wound previously, and in a manner similar to above, the primary winding 306 of a predetermined number of turns is wound along between the windings of the second stage also in the third stage. This reduces the variation in the winding position. Further, as illustrated in FIG. 13C, the wound primary winding 306 is cooled after the self-fusing layer 305 is melted by heat generation by a solvent or energization or heating by an oven, and the primary windings 306 and the primary winding 306 and the upper core 304 are fixed and integrated. In a manner similar to above, as illustrated in FIG. 13D, the secondary winding 303 including the three-layer insulating wire having the self-fusing layer 302 is wound along the outer leg of the U-shaped lower core 301. At this time, the secondary winding 303 is wound along the bottom surface of the lower core 301.

Next, as illustrated in FIG. 13E, the second stage is wound along between the windings of the first stage of the secondary winding 303 wound previously, and the secondary winding 303 of a predetermined number of turns is wound. This reduces the variation in the winding position. Further, as illustrated in FIG. 13F, the wound secondary winding 303 is cooled after the self-fusing layer 302 is melted by heat generation by a solvent or energization or heating by an oven, and the secondary windings 303 and the secondary winding 303 and the lower core 301 are fixed and integrated.

Further, as illustrated in FIG. 13G, the adhesive layer 402 made of epoxy resin or the like is applied to the outer leg of the lower core 301. Finally, as illustrated in FIG. 13H, the upper core 304 to which the primary winding 306 is fixed is turned upside down, and alignment is performed such that the outer leg end surfaces of the lower core 301 and the outer end surfaces of the upper core 304 face each other so as to be aligned. Then, the adhesive layer 402 is thermally cured, and these are integrated to obtain the transformer 206B to be manufactured.

### Effects of Embodiments

As described above, according to the present embodiment, the size reduction is realized by configuring the bobbin-less transformer by the primary winding 306 and the secondary winding 303 formed of the self-fusion wire, and even in the case of the bobbin less, for example, the primary winding 306 is fixed along the middle leg of the upper core 304, and the secondary winding 303 is fixed along the middle leg of the lower core 301. As a result, the variation in the positional relationship between the primary winding 306 and the secondary winding 303 is reduced, and the electrical stability of the leakage inductance 207 and the manufacturability of the transformer can be improved. Accordingly, the reliability can be enhanced. In addition, the bobbin requiring a plurality of dies can be removed, and this can also contribute to cost reduction.

### Modified Embodiments

In the above embodiment, the primary winding 303 has the three-stage configuration, and the secondary winding 306 has the two-stage configuration. However, the present disclosure is not limited to this. Alternatively, even when the primary winding 303 and the secondary winding 306 are disposed on the inner side and the outer side with respect to the inner leg or reversely arranged, the same action and effect can be obtained.

### INDUSTRIAL APPLICABILITY

As mentioned above in details, according to the transformer and the like of the present disclosure, the bobbin-less transformer is configured by the primary winding and the secondary winding made of the self-fusion wire to achieve downsizing. Even in the case of the bobbin less, for example, the primary winding is mounted along the middle leg of the upper core, and the secondary winding is mounted along the middle leg of the lower core. As a result, the variation in the positional relationship between the primary winding and the secondary winding is reduced, and the electrical stability of the leakage inductance and the manufacturability of the transformer can be improved. Therefore, the reliability of the transformer can be enhanced. In addition, the bobbin requiring a plurality of dies can be removed, and this can also contribute to cost reduction.

### EXPLANATION OF REFERENCES

101 On-vehicle charger
102 Commercial AC power supply
103 Rectifying and smoothing circuit
104 Power factor correction circuit (PFC circuit)
105 DC-DC converter
106 Rechargeable battery
201 Inverter circuit
202 to 205 MOS transistor
206, 206A, 206B, 206C, 206D, and 206E Transformer
207 Leakage inductance
208 Excitation inductance
209 Resonance capacitor
210 Rectifier circuit
211 Smoothing capacitor
212 Inductance
220 Control circuit
301, 301A, 301B, and 301C Lower core
302 Self-fusing layer
303 Primary winding
304, 304A, 304B, 304C, 304DA, and 304 DB Upper core
305 Self-fusing layer
306 Secondary winding
401 Gap
402 Adhesive layer
501 Conductor
501a Insulating layer
502 First insulating layer
503 Second insulating layer
504 Third insulating layer
505 Self-fusing layer
601 Adhesive layer
801 Adhesive layer
1001 Insulating elastic body
1201, and 1202 Temporary bobbin

1. A transformer comprising a plurality of cores including a first core and a second core, each of the plurality of cores including a winding mounted to corresponding one of the plurality of cores,
wherein the transformer comprises:
a first winding mounted to the first core; and
a second winding mounted to the second core,
wherein the first core and the second core are arranged to face each other, and
wherein each of the first winding and the second winding is a three-layer insulating wire having a self-fusing layer outside a conductive wire covered with an insulating layer.

2. The transformer as claimed in claim 1,
wherein the first winding and the first core are configured to be connected via the self-fusing layer or an adhesive layer.

3. The transformer as claimed in claim 1,
wherein the first winding is wound and mounted along a middle leg of the first core, and
wherein the second winding is wound and mounted along a middle leg of the second core.

4. The transformer as claimed in claim 1,
wherein the first winding is wound and mounted along a middle leg of the first core, and
wherein the second winding is wound and mounted along an outer leg of the second core.

5. The transformer as claimed in claim 1,
wherein the first core is an E-shaped core, and
wherein the second core is an E-shaped core.

6. The transformer as claimed in claim 1,
wherein the first core is a T-shaped core, and
wherein the second core is a U-shaped core.

7. The transformer as claimed in claim 1,
wherein the first core is an E-shaped core, and
wherein the second core is configured to sandwich a heat-resistant elastic body between two U-shaped cores.

8. A charging apparatus that supplies a charging voltage to a rechargeable battery, the charging apparatus comprising the transformer,
wherein the transformer includes a plurality of cores including a first core and a second core, each of the plurality of cores including a winding mounted to corresponding one of the plurality of cores,
wherein the transformer comprises:
a first winding mounted to the first core; and
a second winding mounted to the second core,
wherein the first core and the second core are arranged to face each other, and
wherein each of the first winding and the second winding is a three-layer insulating wire having a self-fusing layer outside a conductive wire covered with an insulating layer.

9. A power supply apparatus that supplies a power supply voltage to a load, the power supply apparatus comprising the transformer,
wherein the transformer includes a plurality of cores including a first core and a second core, each of the plurality of cores including a winding mounted to corresponding one of the plurality of cores,
wherein the transformer comprises:
a first winding mounted to the first core; and
a second winding mounted to the second core,
wherein the first core and the second core are arranged to face each other, and
wherein each of the first winding and the second winding are a three-layer insulating wire having a self-fusing layer outside a conductive wire covered with an insulating layer.

10. A method of manufacturing a transformer including a plurality of cores including a first core and a second core, each of the plurality of cores including a winding mounted to corresponding one of the plurality of cores,
wherein the transformer comprises:
a first winding mounted to the first core; and
a second winding mounted to the second core,
wherein each of the first winding and the second winding is a three-layer insulating wire having a self-fusing layer outside a conductive wire covered with an insulating layer,
the method of manufacturing the transformer comprising the steps of:
mounting, after disposing the first winding on the first core, the first winding to the first core using the self-fusing layer by heating;
mounting, after disposing the second winding on the second core, the second winding to the second core using the self-fusing layer by heating; and
disposing and bonding the first core and the second core to face each other.
